(19) United States
(12) Patent Application Publication
(10) Pub. No.: US 2019/0110394 A1
(43) Pub. Date: Apr. 18, 2019

(54) CROP YIELD AND OBSTRUCTION DETECTION SYSTEM FOR A HARVESTING HEADER

(71) Applicant: Kopper Kutter, LLC, Cimarron, KS (US)

(72) Inventor: Alan G. VanNahmen, Manhattan, KS (US)

(21) Appl. No.: 16/163,406

(22) Filed: Oct. 17, 2018

Related U.S. Application Data
(60) Provisional application No. 62/707,015, filed on Oct. 17, 2017.

(51) Int. Cl. A01D 34/00; A01B 79/00

(52) U.S. Cl. CPC A01D 34/006; A01B 79/005

(57) ABSTRACT

A system including sensors to sense predefined measurable elements associated with a portion or portions of a utilized width currently engaged in harvesting on and relative to a harvesting mechanism while a harvester traverses a crop field and to output a signal or to adjust an operational characteristic of the harvester or the harvesting mechanism. The system may be configured to sense predefined measurable elements relative to a single crop row or single crop plant of utilized width. The system can be configured to sense predefined measurable elements at a distance between about five feet behind and ten feet in front of the harvesting mechanism. The system may implement a method generally comprising the steps of sensing the predefined measurable element, storing a crop-related data value, and associating the crop-related data value with a time-related data value to adjust the operational characteristics of the harvesting mechanism.

### CROSS-REFERENCE TO RELATED APPLICATIONS

This Application claims priority to U.S. Provisional Patent Application Ser. No. 62/707,015, filed on Oct. 17, 2017, to Alan G. VanNahmen, entitled “Crop Yield and Obstruction Detection System for a Harvesting Header,” currently pending, the entire disclosure of which is incorporated herein by reference.

### FIELD OF INVENTION

The present invention relates generally to crop harvesting machines, and more particularly to a system of sensors and/or cameras for monitoring crop yield, and other measurable crop-related data values, and detecting obstructions, and other harvesting-related elements, at various points on and relative to a harvesting header.

### BACKGROUND OF INVENTION

The level of precision capable in contemporary agricultural processes and methods has improved in recent years with regard to planting and managing large-scale crops, including row crops, such as corn, soybeans, sunflowers, and sorghum, and small-grain crops, such as wheat, barley, rice, oats, and millet. Such methods can be adapted for a variety of agricultural machines, including planters, cultivators, herbicide, insecticide or fertilizer applicators, cutters, mowers, pruners and/or the like. Further, known precision agriculture methods may include variable-rate planting as well as selectively applying pesticides and fertilizers to individual row units or plant units in a manner that prevents substantial overlapping and/or excessive spray patterns and reduces waste. Notably, however, the level of precision in crop harvesting has lagged behind the level of precision available in these other known methods of crop management, which has created a discrepancy in crop-related data collected, sensed, and/or utilized by the agricultural community.

Known systems to facilitate precision crop management generally comprise systems for outputting data with certain resolution, where the term “resolution” refers to the level of detail of the collective data as determined by the smallest unit for which a measurable attribute is sensed or from which a calculable attribute is derived. Applicable data can include attributes or other conditions of the crop, crop field, or harvester or other related and/or applicable characteristics or elements. Generally, the smaller the sensed or measured unit, the greater the resolution. Greater crop-related data resolution facilitates more advanced and sophisticated crop management and crop harvesting.

Agricultural machines and implements used for crop harvesting can comprise various mechanisms configured to gather and harvest a crop, including mechanisms that sever or separate the crop from the remainder of the plant, such as the stalk or chaff. Such mechanisms may include row crop heads, corn heads, grain heads, cut heads, stripper heads, and other harvesting means. Further, such mechanisms may comprise a frame, a plurality of row units, a plurality of tapered crop dividers or snouts, longitudinal passages, a cross auger, an opening, knives or blades, stripper plates, rollers, snapping roles, augers, gathering chains or belts, a reel, bats, tines, and/or the like. Further, it will be appreciated that such harvesting mechanisms may be located at the forward end of, rearward end of, or other location on the agricultural machine or implement and may be permanently attached to the machine or implement and/or interchangeable with a variety of other presently developed or future developed harvesting means.

Traditionally, for crop harvesting, the smallest available sensed or measured unit is typically the harvesting swath, or the utilized width or physical length of the harvesting mechanism, of the harvester, which can be between about eight rows or about sixteen rows of crop plants, or approximately between about twenty feet and about forty feet in length, for example. However, sensed or measured units that are smaller in width are generally preferable for enhanced data resolution related to crop management and crop harvesting, for example on a set width-by-set width basis, a row-by-row basis, or a plant-by-plant basis.

Current means for sensing or measuring crop-related data are not without their deficiencies that make them imprecise or limited in their capabilities to sense or detect crop-related data of a desired amount, type, or nature. One such problem relates to the limited data-collection capabilities of sensing systems currently utilized for crop harvesting. Such systems oftentimes require additional algorithmic steps or timing offset periods before collected data is available for analysis or application. For example, sensing systems may utilize sensors or devices that are limited to or specifically directed to collecting data related to crop yield, or similar measurable data, that oftentimes requires the collected data to be correlated with additional data, which could have been synchronously or asynchronously collected, to compute, correlate, or confirm deliverable data before the deliverable data can be output. This additional step of correlation may require the sensing system to accommodate timing offset periods of between about one second or about seven seconds. In yet a more specific example, certain sensors and devices may be directed to measuring crop yield through mass or volume flow by correlating the number of sensed crop plant stalks to historical and/or statistical data before any usable deliverable data can be derived and/or output. These necessary, additional steps or functions, and the associated timing offset periods, necessarily limit the ability for such sensing systems to render data or computations for instantaneous output, analysis, application, and/or use.

Another problem relates to the nature and limiting physical and structural characteristics of the harvesting mechanisms to which sensing systems are often coupled. Specifically, sensors or devices of sensing systems adapted for collecting crop-related data values during harvesting are oftentimes limited in size, location, and capabilities by the dimensions and other features of the harvesting mechanism. For example, known crop-data sensing systems can include yield monitoring devices positioned at an opening in the harvesting mechanism or at the clean grain elevator to which the harvesting mechanism directs harvested crop (e.g., grain) after its separation from the material other the grain (“MOG”) for example. In this way, such sensing systems are limited to collecting only aggregated crop-related data values relative to the crops being harvested along the entire length or utilized width of the harvesting head, and therefore data collected via such sensing systems lacks the precision necessary for modern day crop management and crop harvesting.

Therefore, a sensing system with enhanced capabilities to sense, collect, and gather crop-related data values of different types and kinds, and at higher levels of precision and at elevated quantities, are desirable for use with crop harvesting machines and/or implements, including to more accurately measure the flow of the harvested crop, to detect anomalies in crop yield and possible obstructions or impurities in the crop flow, and to detect, measure, analyze and/or navigate the terrain of a crop field. Further, such sensing systems are desirable for use with presently developed or future developed harvesting means, including, without limitation, for use with semi-autonomous or autonomous harvesting machines or implements. Accordingly, a need exists for an improved means or systems of sensing or detecting crop-related data values.

### SUMMARY OF THE INVENTION

The present invention is directed generally to a system of sensors for sensing predefined measurable elements on and relative to a harvesting mechanism while a harvester traverses a crop field.

According to one embodiment, the system may generally comprise a first sensor to sense a predefined measurable element associated with a first portion of a plurality of portions, independent of other portions of the plurality of portions, of a utilized width currently engaged in harvesting and output a first crop-related data value, a second sensor to sense a predefined measurable element associated with the first portion of the plurality of portions of the utilized width currently engaged in harvesting and output a second crop-related data value, and at least one processing unit in communication with an output module, wherein the at least one processing unit can receive the first crop-related data value and the second crop-related data value and cause the output of a signal based on the first crop-related data value and the second crop-related data value via the output module. Further, the first portion can comprise a single crop row of the utilized width or a single crop plant of the utilized width; however, it will be appreciated that it may also include multiple crop rows or other defined widths. Further yet, the signal can comprise a warning to an operator of the harvester. The output module can be configured to adjust an operational characteristic of the harvester or the harvesting mechanism upon instruction from the at least one processing unit. Such an adjustment in an operational characteristic may include, but is not limited to, speeding up, slowing down, or stopping the harvester; raising, lowering, or otherwise moving the harvesting mechanism or a component thereof; starting, stopping, speeding up, or slowing down one or more elements of the harvester and/or the harvesting mechanism; adjusting the steering or direction of the harvester; outputting a signal to an external source; or any other suitable or desired adjustment to the harvester and/or the harvesting mechanism. The system may further include a timekeeping device configured to generate a time-related data value relative to the operation of the harvester, wherein the at least one processing unit causes the output of a signal based on the first crop-related data value, the second crop-related data, and the time-related data value via the output module, for example. Further, the system may comprise an input module to generate an input value, wherein the at least one processing unit causes the output of a signal based on the first crop-related data value, the second crop-related data, and the input value via the output module.

According to one embodiment, the system may be supported by a harvesting mechanism, such as a header. Further, the first sensor can configured to sense the predefined measurable element at a first distance relative to the harvesting mechanism, and the second sensor can be configured to sense the predefined measurable element at a second distance relative to the harvesting mechanism. For example, the first sensor can be configured to sense the predefined measurable element at a first distance between about five feet behind and ten feet in front of the harvesting mechanism (e.g., seven feet in front in one embodiment), and the second sensor can be configured to sense the predefined measurable element at a second distance between about five feet behind and ten feet in front of the harvesting mechanism (three feet behind in one embodiment).

According to one embodiment, the system may be supported by a harvesting mechanism that can be operably attached to an agricultural machine or a harvesting machine.

According to one embodiment, the system may implement a method for measuring a crop-related data value as a harvester traverses a crop field, where the method generally comprises the steps of (a) sensing a predefined measurable element associated with a first sensor at a first distance between about five feet behind and ten feet in front of a harvesting mechanism, the first sensor generating a first crop-related data value related to the predefined measurable element, (b) storing the first crop-related data value in a memory, (c) recording a first time-related data value of a timekeeping module, where the timekeeping module in communication with the memory, and (d) storing in memory a first association between the first crop-related data value and the first time-related data value. The method may also include the step of (e) adjusting an operational characteristic of the harvesting mechanism based on the first crop-related data value via an output module upon instruction from an at least one processing unit. Further, the method may generally comprise the steps of (f) sensing a predefined measurable element associated with a second sensor at a second distance between about five feet behind and ten feet in front of a harvesting mechanism, the second sensor generating a second crop-related data value related to the predefined measurable element, (g) storing the second crop-related data value in the memory, (h) recording a second time-related data value of the timekeeping module, (i) storing in memory a second association between the first crop-related data value and the first time-related data value, and storing in memory a third association between the first association and the second association. Additionally, the method may comprise the step of (k) adjusting an operational characteristic of the harvesting mechanism based on the first crop-related data value and the second crop-related data value via the output module upon instruction from the at least on0e processing unit.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is a side elevation view of a conventional combine harvester adapted for attachment with a harvesting mechanism, such a corn head or grain head, suitable for modification by the present invention;

FIG. 2 is a front view of a conventional corn head or row crop head adapted for attachment to a combine harvester suitable for modification by the present invention;

FIG. 3 is a front view of a conventional grain head adapted for attachment to a combine harvester suitable for modification by the present invention;

FIG. 4 is a schematic illustration of an example sensing system in accordance with one embodiment of the present invention;

FIG. 5 is a schematic illustration of a portion of the sensing system of FIG. 4;

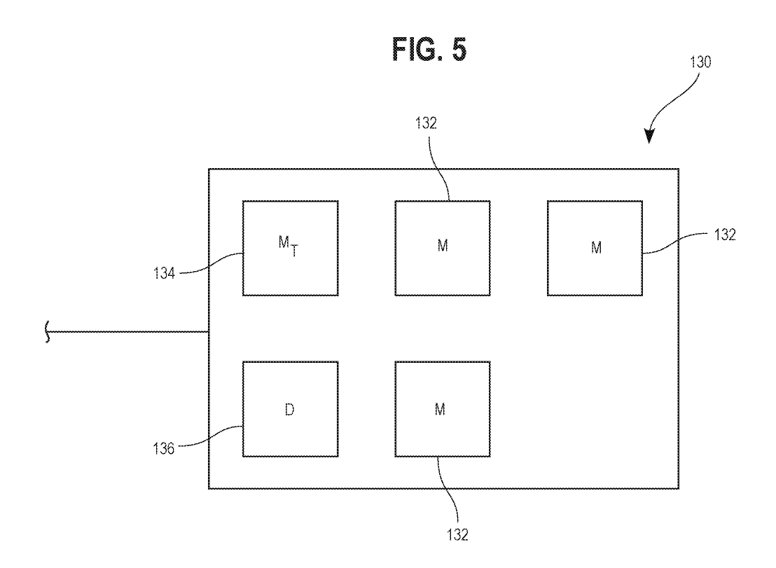

FIG. 6 is a schematic illustration of a portion of the sensing system of FIG. 4;

FIG. 7 is a front view of a corn head or row crop head adapted for attachment to a combine harvester modified by the present invention;

FIG. 8 is a front view of a grain head adapted for attachment to a combine harvester modified by the present invention;

FIG. 9 is a side elevation view of an example sensing system comprising the sensing system of FIG. 4;

FIG. 10 is a flow diagram of an example method that may be carried out by the sensing system of FIG. 4; and

FIG. 11 is a flow diagram of an example method that may be carried out by the sensing system of FIG. 4.

### DETAILED DESCRIPTION OF THE INVENTION

Various embodiments of the present invention are described and shown in the accompanying drawings. For purposes of clarity in illustrating the characteristics of the present invention, proportional relationships of the elements have not necessarily been maintained in the drawings. It will be appreciated that any dimensions included in the drawings are simply provided as examples and dimensions other than those provided therein are also within the scope of the invention.

The description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

One objective of the present invention is to provide a system for sensing crop-related data values, such as crop yield, and detecting obstructions at various points on and relative to a harvesting header with increased precision and reliability compared to previously known means. Another objective of the present invention is to provide a system for navigating the terrain of a crop field. A further objective of the present invention is to provide a system capable of adaptively sensing, collecting, or otherwise utilizing precise crop-related data values for purposes of enhancing and improving crop management, crop harvesting, and the like.

One embodiment of the present invention is designed to provide a sensing system for an agricultural machine or implement associated with crop harvesting, such as a combine or other harvester, that can comprise a plurality of sensors or devices for sensing or detecting, at a given time, crop-related data values, including the but not limited to, crop yield, volumetric flow, mass flow, moisture content, and/or other quantitative or qualitative characteristics or values of the harvested crop. Such system being configured to specifically sense predefined measurable elements or conditions of crop plants, including but not limited to, the number of individual crop stalks or plants, the amount of crop or groups of crop plants, the dimensions of an individual crop plant, the relative proportions of the different portions of an individual crop plant, the mass or volume of the grain or product of an individual crop plant or group of plants, the MOG of an individual crop plant or group of plants, crop residue, other crop-related variables, and the like.

Another embodiment of the present invention is designed to provide a system for monitoring or observing the intake or ingestion of the harvested crop or other items for purposes of measuring, calculating, or otherwise analyzing certain predefined measurable elements or conditions of the harvested crop or other items. Such a system being configured to specifically sense predefined measurable elements or conditions of the harvested crop or other items, including but not limited to, the type of an individual crop plant or group of plants, the nature of an individual crop plant or group of plants, other characteristics of an individual crop plant or group of plants, the presence of non-crop foreign items (e.g., trees, bushes, non-crop plants, well heads, drainage stand pipes, fence, fence posts, powerline posts, above-ground utilities, farm machinery and implements, wildlife, other hazards, and the like), the number of non-crop foreign items, the type of an individual non-crop foreign item or group of items, the nature of an individual non-crop foreign item or group of items, other characteristics of an individual non-crop foreign item or group of items, and the like. Further, such a system can be capable of providing an output, signal, or digital or audible warning or be otherwise capable of manipulating or automatically adjusting the harvesting mechanism or its operational characteristics to avoid, prevent, or otherwise mitigate undesired collection of harvested crops or other items, the unnecessary wear and tear of the harvesting mechanism and its components, or damage to the harvesting mechanism, the harvester, or any other related agricultural machines or implements associated with crop harvesting.

Yet another embodiment of the present invention is designed to provide a system for detecting, measuring, analyzing and/or navigating the terrain of the crop field to avoid, prevent, or otherwise mitigate the unnecessary wear and tear of the harvesting mechanism and its components or damage to the harvesting mechanism, the harvester, or any other related agricultural machines or implements associated with crop harvesting. Such a system being configured to specifically sense predefined measurable elements or conditions of the harvested crop, other items, and the crop field, including but not limited to, the type of an individual crop plant or group of plants, the nature of an individual crop plant or group of plants, other characteristics of an individual crop plant or group of plants, the presence of non-crop foreign items (e.g., trees, bushes, non-crop plants, well heads, drainage stand pipes, fence, fence posts, powerline posts, above-ground utilities, farm machinery and implements, wildlife, other hazards, and the like), the number of non-crop foreign items, the type of an individual non-crop foreign item or group of items, the nature of an individual non-crop foreign item or group of items, other characteristics of an individual non-crop foreign item or group of items, the planting configuration, pattern, or patterns of the crop or crops of the crop field, the pattern or patterns of crop growth of the crop or crops of the crop field, the slope of the crop field, the presence or ruts or ridges in the crop field, the presence of rises or runs in the crop field, the presence of yield-reducing soil compaction, pinch row effect, wet spots, dry spots, weed patches, washout, yield-reducing chemical applications, and nutrient deficiencies, other the physical characteristics of the crop field, and the like. Further, such a system being capable of providing an output, signal, or digital or audible warning to an operator or a computer, or other processor, for purposes of manually or automatically adjusting the harvester, the harvesting mechanism, or the operational characteristics of either relative to the detected, measured, analyzed, and/or navigated terrain.

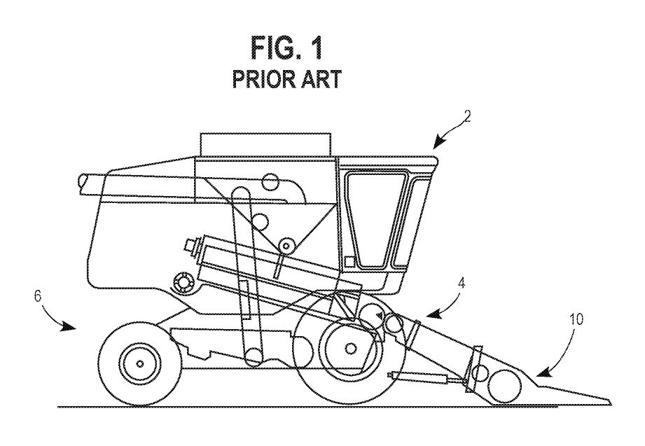

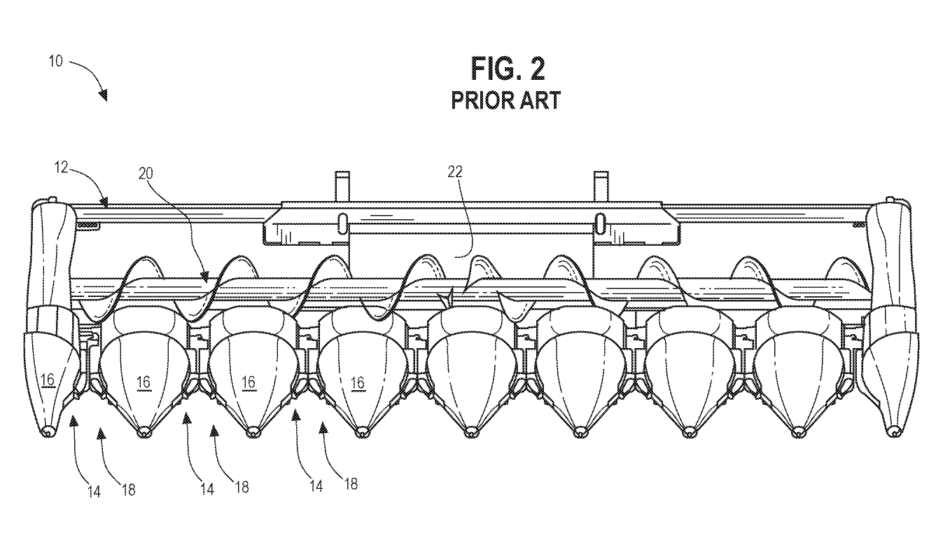

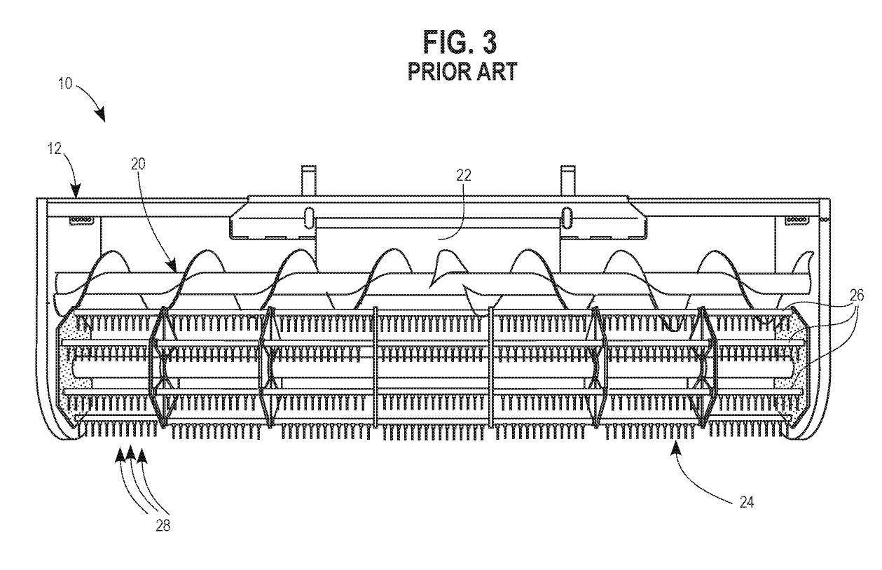

FIG. 1 depicts a conventional combine harvester 2. The harvester 2 comprises a harvesting head or mechanism 10 located at its forward end 4. Conventional harvesting mechanisms 10 can comprise various devices configured to collect, gather, intake and harvest a crop, including devices that sever or separate the crop from the remainder of the plant, such as the stalk or chaff, and direct the crop into the harvester 2. A harvesting mechanism 10 may be configured as a variety of harvesting headers, including, without limitation, row crop heads, corn heads, grain heads, cut heads, stripper heads, swather heads, pickup heads, draper heads, and other suitable presently known or hereafter developed harvesting headers. Further, as depicted in FIG. 2, the harvesting mechanism 10 may generally comprise a frame 12, a plurality of row units 14, a plurality of tapered crop dividers or snouts 16, longitudinal passages 18, cross auger 20, and an opening 22, Alternatively, as depicted in FIG. 3, the harvesting mechanism 10 may generally comprise a frame 12, a cross auger 20, an opening 22, a reel 24, a plurality of bats 26, a plurality of tines 28, and/or the like. One or more embodiments of the harvesting mechanism 10 may further include components such as knives, blades, stripper plates, conditioning rollers or other rollers, snapping rolls, gathering chains, conveying belts, and/or the like.

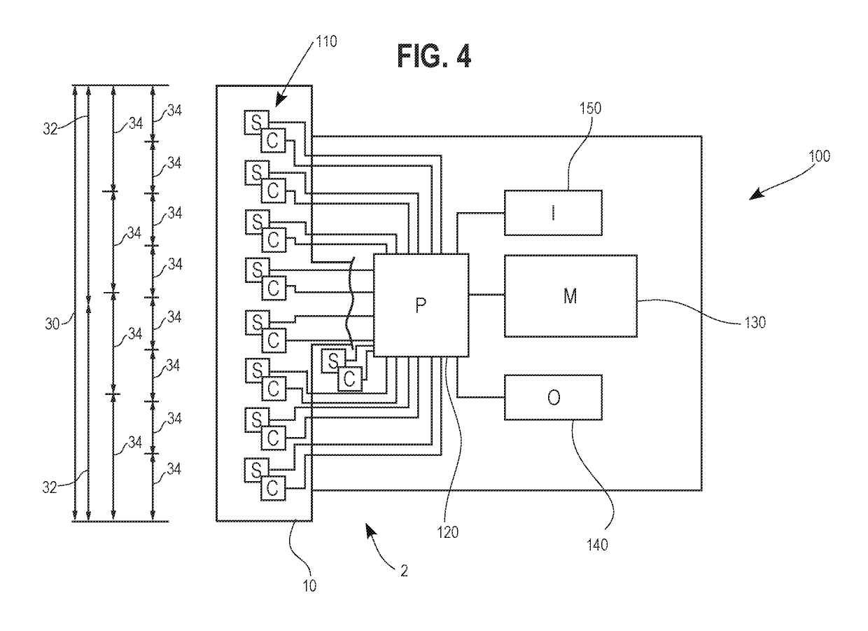

As best depicted by FIG. 4, in a preferred embodiment of the present invention, the sensing system 100 can be adapted for use with a harvester 2 and can generally comprise at least one sensor or device 110, or cluster of sensors and devices 110, a processor 120, a memory 130, and an output module 140. In another embodiment, the sensing system 100 can further comprise an input module 150. Although the sensing system 100 is depicted in a manner that the sensors or devices 110, or the cluster of sensors and devices 110, the processor 120, the memory 130, the output module 140, and the input module 150 are part of and carried by the harvester 2, it will be appreciated that one or more of such components, including any sub-element of the processor 120 and/or the memory 130, may alternatively be located remotely from the harvester 2 and in communication with the harvester 2 in a wireless fashion.

In one embodiment of the present invention, the harvester 2 generally comprises a harvesting mechanism 10 configured to collect, gather, and/or harvest crops along the swath length or utilized width 30 of the harvesting mechanism 10, wherein the utilized width 30 of the harvesting mechanism 10 constitutes that portion of length or swath that is being utilized to collect, gather, and/or harvest crops at a given time. Although, the utilized width 30 in most instances is generally equal to the physical length of the swath of the harvesting mechanism 10, for example, between about eight rows or about sixteen rows of crop, or approximately between about twenty feet and about forty feet. However, in some circumstances, the utilized width 30 may constitute only a portion of the swath of the harvesting mechanism 10, such as along an end row, waterway and/or the like.

In one embodiment of the present invention, the sensor or sensing device 110 can be adapted to sense or detect predefined crop-related data values, including, without limitation, certain elements or conditions of the crop (e.g., the number of individual crop stalks or plants, the amount of crop or groups of crop plants, the dimensions of an individual crop plant, the relative proportions of the different portions of an individual crop plant, the mass or volume of the grain or product of an individual crop plant or group of plants, the MOG of an individual crop plant or group of plants, crop residue, other crop-related variables, the type of an individual crop plant or group of plants, the nature of an individual crop plant or group of plants, other characteristics of an individual crop plant or group of plants, and the like), crop field (e.g., the planting configuration, pattern, or patterns of the crop or crops of the crop field, the pattern or patterns of crop growth of the crop or crops of the crop field, the slope of the crop field, the presence or ruts or ridges in the crop field, the presence of rises or runs in the crop field, the presence of yield-reducing soil compaction, pinch row effect, wet spots, dry spots, weed patches, washout, yield-reducing chemical applications, and nutrient deficiencies, other the physical characteristics of the crop field, and the like), or harvester 2 (e.g., the speed of the harvester, the distance traversed by the harvester, the operating status of the harvester and its sub-elements, the loading capacity of the grain tank, and the like) or other related and/or applicable characteristics or elements. As used herein, the sensors or devices 110 of the sensing system 100 can be at least one of or any combination of the following: impact sensors, strain gauges, accelerometers, non-physical contact sensors, acoustic sensors, infrared sensors, RADAR sensors, light detection and ranging (“LIDAR”) sensors, ultrasonic sensors, digital cameras or other optical instruments, structured light or stereo camera vision sensors, speed sensors, capacitive moisture sensors, mass flow sensors, yield sensors, global positioning system (“GPS”) sensors, combinations of the foregoing, or any other suitable presently known or future developed sensing means. As described herein, the configuration of sensors or devices 110 of the sensing system 100, and any combination of the identified sensors, can be configured in a way that is an improvement over known sensing means. For example, the sensors or devices 110 of the sensing system 100, which may comprise a combination of non-physical sensors and/or digital cameras, are an improvement in terms of precision, reliability, and accuracy over acoustic sensors and impact sensors that that rely on certain sensed or detected crop-related data values as a proxy for the desired crop-related data values (e.g., relying on the number of stalks to determine the crop yield of a harvest).

Further, it will be appreciated that the sensors or devices 110, or any cluster of sensors and devices 110, can be comprised of different types of sensing means that sense different events, stimulus and/or crop-related data values. In one embodiment of the present invention, digital cameras or other optical instruments can be used to capture images or video of the harvested crop plant prior to, during, and after harvesting. Such images and video can be utilized in several ways, including for instantaneous analysis and correlation or application with other crop-related data values as well as subsequent analysis and review at some time after the harvesting of the crop.

In one embodiment of the present invention, the sensing system 100 is configured to sense, gather, or collect crop-related data values at a less-than-whole portion or a fraction of the crop being harvested along the utilized width 30 of the harvesting mechanism 10 of the harvester 2. As illustrated in FIG. 4, the swath length or utilized width 30 of the harvesting mechanism 10 may be portioned or divided into a plurality of equal or unequal portions 32, which can be further divided into a plurality of equal or unequal sub-portions 34, wherein at least one sensor or device 110, or at least one cluster of sensors and devices 110, can correspond with each portioned or divided portion 32, 34 of the harvesting mechanism 10. The portioned or divided portions 32, 34 can correspond with a predefined width or the width of a crop plant or row of crops. Each portion 32, 34 of the harvesting mechanism 10 can be adapted to gather and/or harvest crops from a distinct region of a crop field, and the sensor or device 110, or the cluster of sensors and devices 110, are capable of sensing, gathering, or collecting crop-related data values related to the respective portion or portions 32, 34 to which it is assigned or related to individual crop plants or rows of crop plants. For example, where the utilized width 30 of the harvesting mechanism 10 is portioned or divided into n number of portions 32, 34, the sensors or devices 110, or the clusters of sensors and devices 110, associated with the individual portion n are adapted for providing crop-related data values of crops received by portion n of the harvesting mechanism 10; the sensors or devices 110, or the clusters of sensors and devices 110, associated with the individual portion n-1 are adapted for providing crop-related data values received by portion n-1 of the harvesting mechanism 10; the sensors or devices 110, or the clusters of sensors and devices 110, associated with the individual portion n-2 are adapted for providing crop-related data values received by portion n-2 of the harvesting mechanism 10; and so on and so forth. However, it will be appreciated that the sensors or devices 110, or the clusters of sensors and devices 110, can be configured to sense, gather, or collect crop-related data values outside or beyond the utilized width 30 of the harvesting mechanism 10. For example, the sensors or devices 110, or the clusters of sensors and devices 110, can be configured to sense, gather, or collect crop-related data values at varying distances at the edges or the periphery of the harvesting mechanism, which may not be directly in front of the harvesting mechanism 10 or within an area covered by the utilized width 30.

It will be appreciated that the sensors or devices 110, or the clusters of sensors and devices 110, can be configured to sense, gather, or collect crop-related data values in parallel as well as in series. For example, in one embodiment, an at least one sensor or device 110, or cluster of sensors and devices 110, senses, gathers, or collects crop-related data values for an individual portion 32, 34; while in another embodiment, an at least one sensor or device 110, or cluster of sensors and devices 110, senses, gathers, or collects crop-related data values for an individual portion 32, 34, and another at least one sensor or device 110, or cluster of sensors and devices 110, senses, gathers, or collects crop-related data values for a plurality of portions 32, 34. In such instance, the sensor or device 110, or the cluster of sensors and devices 110, may be of the same type sensing the same or different crop-related data values, or of different types sensing the same or different crop-related data values. In this manner, any set of sensors or devices 110, or the cluster of sensors and devices 110, can collect disparate, supplemental, and/or redundant crop-related data values for purposes of being derived, correlated, and/or analyzed by a processor 120. Further, although individual portions 32, 34 are each illustrated as being associated with a single sensor, device, or cluster of sensors and devices 110, in other embodiments, each of the portions 32, 34 may be associated with multiple or any number of sensors, devices, or clusters of sensors and devices 110.

In one embodiment, the sensors or devices 110, or the cluster of sensors and devices 110, can be in communication with a processor 120. As best illustrated in FIG. 4, the processor 120 can be in further communication with additional processors, a memory 130, an output module 140, and/or an input module 150. In another embodiment, the sensors or devices 110, or the cluster of sensors and devices 110, can be in communication with a controller that comprises a processor 120 and a memory 130.

The processor 120 can be configured to be instructed or directed by an individual or an operator via the input module 150 and/or the memory 130, or in some similar manner. In one embodiment, the processor 120 can generally comprise one or more processing units configured to carry out instructions either hardwired as part of an application-specific integrated circuit or provided as code or software stored in the memory 130.

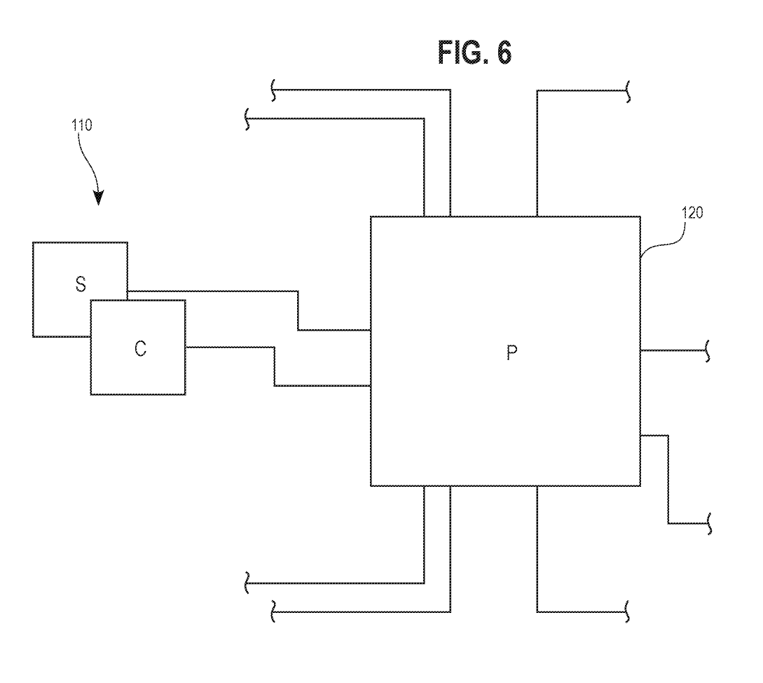

In one embodiment of the present invention, the memory 130 can comprise a non-transient computer-readable medium or persistent storage device for storing data or other information for use by the processor 120 or generated by the processor 120. The memory 130 can further store instructions in the form of code or software for the processor 120. In one embodiment, the memory 130 can be carried by the harvester 2; however, in another embodiment, the memory 130 can be provided remote from the harvester 2. As best illustrated in FIG. 6, the memory 130 can be configured to comprise a plurality of modules 132 for a variety of purposes, including, without limitation, modules that contain historical data, facilitate data analysis, store crop-related data values derived from the harvested crop, or comprise programming, software or code for directing the operation of the processor 120 for receiving, deriving, identifying, correlating, analyzing, generating, utilizing, and/or applying crop-related data values sensed, gathered, or collected by the sensors or devices 110, or the cluster of sensors and devices 110. In one embodiment, the memory 130 can comprise a timekeeping device or module 134 that is configured for tracking and correlating certain time-related data values, which can be derived from a clock or the machine-relative position or operation of the harvester 2 or harvesting mechanism 10 and relate to a particular time elapsed, particular distance traversed, or a particular number of sensed or detected crop plants. In one embodiment, the memory 130 can comprise a database 136. In one embodiment, the database 136 can be a static database comprised of data regarding historical or predefined data, such a planting data, historical yield information, historical field or soil data, and crop-related data values sensed or derived by the sensing system 100. The database 136 can also comprise a learned database comprised of data that varies as the harvester 2 travels across the crop field and/or the sensing system 100 senses or derives crop-related data values. In one embodiment, the database 136 can be a learned database that comprises data values derived, correlated, or calculated through a recursive and/or iterative function performed by the processor 120 or some other element of the sensing system 100, whereby an artificial neural network learning algorithm or a predictive model can be used to derive an analytical map of sensed, detected, observed, derived, correlated, and/or calculated values about an element to conclusions about a targeted value for that element.

The output module 140 can be configured to provide, upon instruction from the processor 120, an output, signal, or digital or audible warning to an operator or a computer, or other processor, for purposes of manually or automatically adjusting the harvester, the harvesting mechanism, or the operational characteristics of either. Further, the output module 140 can generally comprise a display and/or a warning system. The display comprises a device by which information can be visually presented to an operator of the harvester 2 or the harvesting mechanism 10 or to a remotely located monitor, manager, or operator of the harvester 2 or the harvesting mechanism 10. Further, the display may comprise a monitor or screen that is stationary in nature or that is mobile in nature. A mobile display can be a computer tablet, smart phone, personal data assistant (“PDA”) and/or the like.

The input module 150 can comprise one or more devices by which controls and input may be provided to the processor 120, such as a keyboard, touchpad, touch screen, steering wheel or steering control, joystick, microphone with associated speech recognition software and/or the like. The input module 150 can be configured to facilitate remote steering when the harvester is configured to be remotely controlled or remotely steered.

In one embodiment of the present invention, the sensing system 100 and the elements thereof can be used to identify conditions or relevant variables of the crop field, such as the slope of the crop field, the presence or ruts or ridges in the crop field, the presence of rises or runs in the crop field, the presence of yield-reducing soil compaction, pinch row effect, wet spots, dry spots, weed patches, washout, yield-reducing chemical applications, and nutrient deficiencies, other the physical characteristics of the crop field, and the like, and cross-compare and analyze sensed and derived crop-related with other crop-related data values, including current and/or historical planting data and other input and yield data related to the locality of the crop field and crops. Such sensed and derived information can be helpful and valuable for purposes of crop management and crop harvesting.

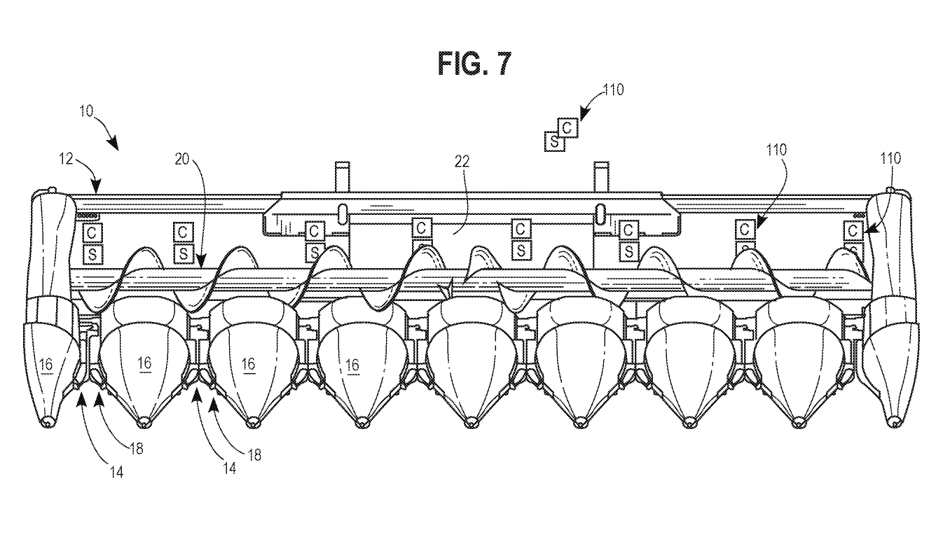

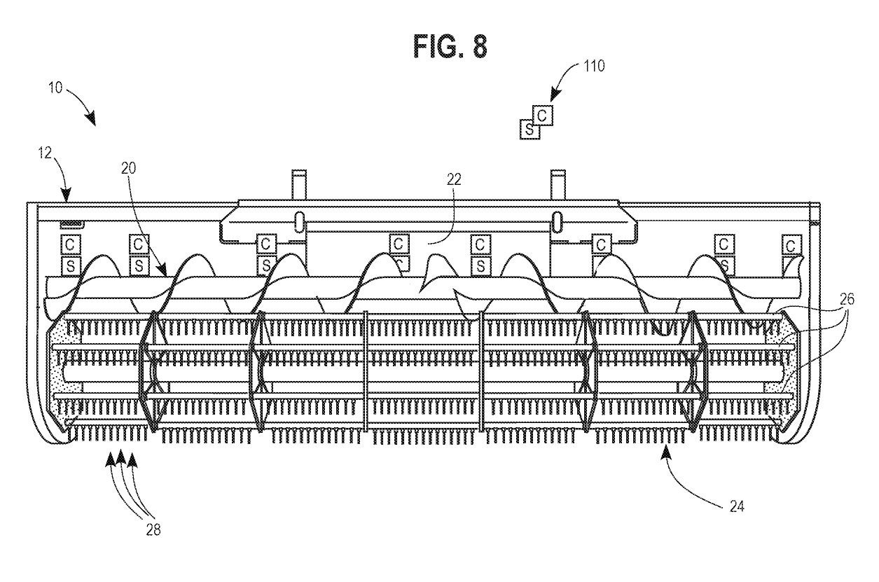

In one embodiment of the present invention, the sensors or devices 110, or the cluster of sensors and devices 110, may be located, supported, or operably coupled to the harvesting mechanism at a variety of locations. For example, as best illustrated in FIGS. 7 and 8, the sensors or devices 110 or the cluster of sensors and devices 110, can be located at the rear of the harvesting mechanism 10, for example mounted to the frame 12 or within the harvesting mechanism 10 and/or the row units 14. Alternatively, the sensors or devices 110, or the cluster of sensors and devices 110, can be located on any portion of the harvesting mechanism 10 forward of the frame 12, such as on a row unit 14 or on a divider or snout 16 of the harvesting mechanism 10.

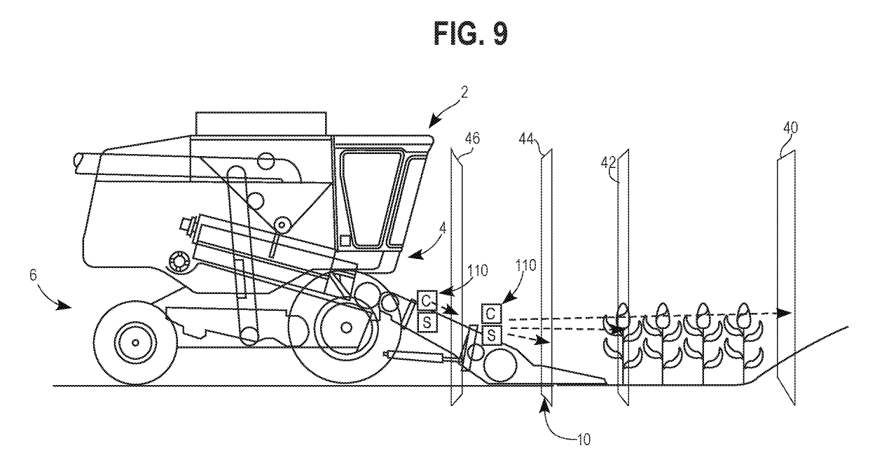

In one embodiment of the present invention, the sensing system 100 can be configured to simultaneously and/or sequentially sense, gather, or collect crop-related data values at varying distances or spatial planes relative to the harvesting mechanism 10 through a combination of sensing means, including LIDAR sensors and digital cameras or other optical instruments. As illustrated in FIG. 9, in one embodiment, the sensors or devices 110, or the cluster of sensors and devices 110, can be configured to sense, gather, or collect crop-related data values at a first plane 40 located generally in front of the harvesting mechanism 10, for example, at between about five feet and about ten feet in front of the harvesting mechanism 10. However, it will be appreciated that the first plane may be located at other distances, for example, twenty feet, forty feet, sixty feet, or any other suitable distance in front of the harvesting mechanism 10.

Further, the sensors or devices 110, or the cluster of sensors and devices 110, can be configured to sense, gather, or collect crop-related data values at a second plane 42 located more immediately in front of the harvesting mechanism 10. Further yet, the sensors or devices 110, or the cluster of sensors and devices 110, can be configured to sense, gather, or collect crop-related data values at a third plane located generally within the harvesting mechanism 10, for example at some point within the row unit 14, thresher, or other device employed with the harvesting mechanism 10 for purposes of severing and/or separating the crop from the remainder of the plant. Even further yet, the sensors or devices 110, or the cluster of sensors and devices 110, can be configured to sense, gather, or collect crop-related data values at a fourth plane 46 located generally after the row unit 14, thresher, or other device employed with the harvesting mechanism 10 for purposes of severing and/or separating the crop from the remainder of the plant, for example at the opening 22 of the harvesting mechanism, which can lead to a clean grain elevator or other auger. Although the preceding paragraph discloses four planes from which the sensors or devices 110, or the cluster of sensors and devices 110, can be configured to sense, gather, or collect crop-related data values, it will be appreciated that the sensors or devices 110, or the cluster of sensors and devices 110, can be configured to sense, gather, or collect crop-related data values at any number of planes and at any distances relative to the harvesting mechanism 10 or other identified planes.

Although the harvester 2 is described and illustrated as a traditional combine harvester, in other embodiments, the harvester 2 may comprise other types of agricultural harvesting machines, including, without limitation, self-propelled forage harvesters, sugar cane harvesters, swathers or windrowers, rotary combines, combines having a transverse threshing cylinder and straw walker, or combines having a transverse threshing cylinder and rotary separator rotors. Further, although the harvester 2 is illustrated as being supported and propelled on ground-engaging wheels, it can also be supported and propelled by full tracks or half-tracks. Further yet, although the harvesting mechanism 10 is illustrated as being located at a forward end 4 of the harvester 2, it will be appreciated that the harvesting mechanism 10 may be located and supported at other locations on the harvester 2, including, without limitation, the rearward end 6 of the harvester 2, and may be permanently attached to the harvester 2 and/or interchangeable with a variety of other presently developed or future developed harvesting means or mechanisms.

In a preferred embodiment of the present invention, crop-related data values collected from the first plane 40, the second plane 42, the third plane 44, and/or the fourth plane 46 by the sensors or devices 110, or the cluster of sensors and devices 110, can be used to monitor, observe or detect the intake or ingestion of the harvested crop or other items for purposes of measuring, calculating, or otherwise analyzing certain predefined measurable conditions or elements of the harvested crop or other items. Such collected crop-related data values can be correlated with modules 122 or other data to provide an output, signal, or digital or audible notice, message, or warning via the output module 140 or otherwise manipulate or automatically adjust the operational characteristics of the harvester 2 and/or the harvesting mechanism 10. For example, correlated crop-related data values can be used to operate an actuator for purposes of manipulating or automatically adjusting the operational characteristics of the harvester 2 and/or the harvesting mechanism 10 as a reaction to certain sensed crop-related data values or identified conditions.

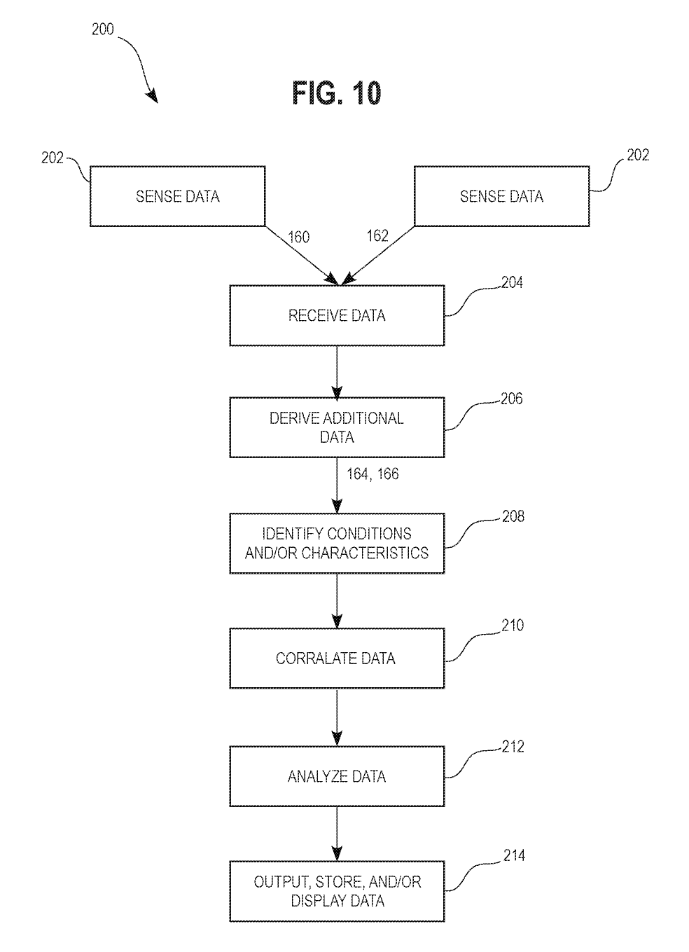

FIG. 10 is a diagram depicting an example method 200 for detecting and avoiding obstructions or other elements that may be carried out by or in conjunction with the sensing systems 100 in accordance one embodiment of the present invention. As indicated by blocks 202, a plurality of sensors or devices 110, or cluster of sensors and devices 110, can sense or detect certain predefined crop-related data values, including crop-related data values sensed or detected from a certain portion or portions 32, 34 of the harvesting mechanism 10. Block 204 illustrates how the processor 120 can receive sensed crop-related data values from the plurality of sensors or devices 110, or cluster of sensors and devices 110. For example, the processor 120 can receive first crop-related data values 160 and second crop-related data values 162 from one sensor or device 110, or cluster of sensors and devices 110, or from a plurality of sensors or devices 110, or clusters of sensors and devices 110. As indicated by block 206, according to one embodiment of the present invention, the processor 120 can derive additional secondary crop-related data values 164 and/or tertiary crop-related data values 166 from the first crop-related data values 160 and second crop-related data values 162 based on predefined characteristics, parameters, or thresholds. As indicated by block 208, the processor 120 can then identify certain predefined conditions or characteristics from the crop-related data values provided to and derived by the processor 120 based on predefined characteristics, parameters, or thresholds. Then, as indicated by block 210 and in accordance with one embodiment of the present invention, the processor 120 can correlate the applicable crop-related data values upon instructions provided by the memory 130 or a module 132 contained therein. Such correlation can include weighting and combining the received and/or derived crop-related data based on predefined parameters, correlating the relevant crop-related data values to the time-related data values provided by a timekeeping module 134 of the memory 130, and/or combining or integrating first crop-related data values 160, second crop-related data values 162, second crop-related data values 164, tertiary crop-related data values 166, and/or any other applicable crop-related data values. As indicated by block 212, the processor 120 can analyze the received and/or derived data based upon instructions provided by the memory 130, including instructions to conduct known data or statistical analysis. Block 214 indicates how the processor 120 can generate deliverable data or signals following instructions provided by the memory 130 or a module 132 contained therein. Such deliverable data or signals can be determined on a set width-by-set width basis, row-by-row basis, or a plant-by-plant basis. Further, such deliverable data can comprise crop-related data values, including aggregated crop-related data values, or other information and notifications. For example, in one embodiment, a visible or audible alert or notice may be output by the output module 140 in response to analysis conducted by the processor 120. Further yet, such deliverable data or signals can be output, stored, or otherwise displayed for purposes of analyzing the crop-related data values and/or operating the harvester 2 or the harvesting mechanism 10. In one embodiment, the processor 120 can store the deliverable data in the memory 130 or transmit the deliverable data to a remote database or memory location via a wired or wireless connection. In another embodiment, the deliverable data can be output via a wireless communication device, a removable memory port (e.g., a USB port), or other device for transmitting data to and from the processor 120 or the output module 140.

In another embodiment of the present invention, crop-related data values collected from the first plane 40 or second plane 42 by the sensors or devices 110, or the cluster of sensors and devices 110, can be used to detect, measure, analyze and/or navigate the terrain of the crop field to avoid, prevent, or otherwise mitigate the unnecessary wear and tear of the harvesting mechanism 10 and its components or damage to the harvesting mechanism 10, the harvester 2, or any other related agricultural machine or implement associated with crop harvesting. Such collected crop-related data values can be correlated with modules 122 or other data to provide an output, signal, or digital or audible notice, message, or warning via the output module 140 or otherwise manipulate or automatically adjust the operational characteristics of the harvester 2 and/or the harvesting mechanism 10, either manually or automatically, relative to the detected, measured, analyzed, and/or navigated terrain.

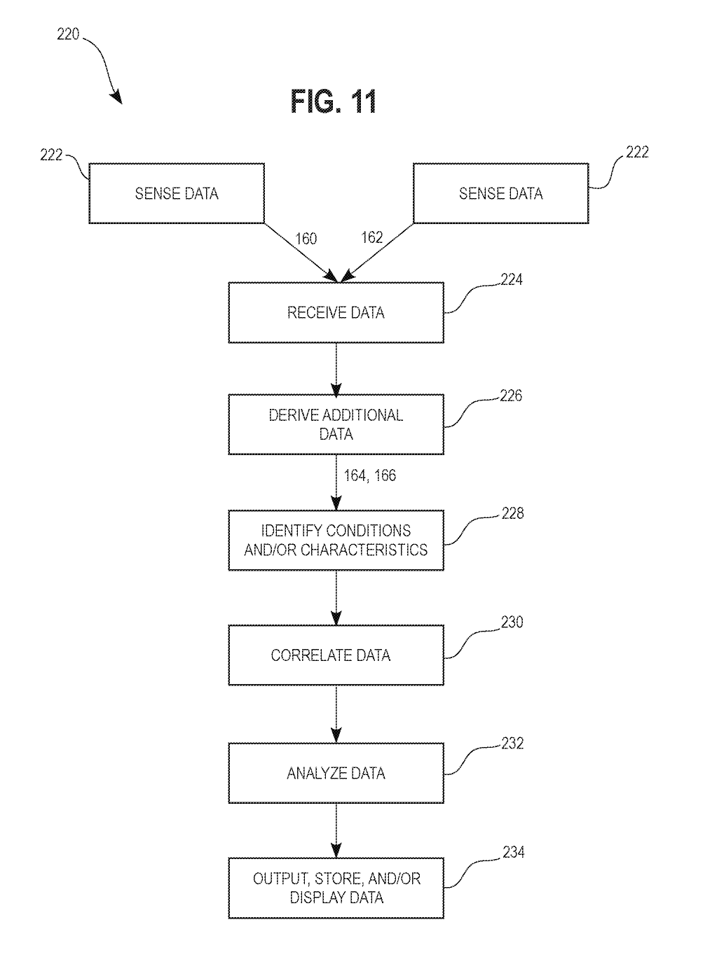

FIG. 11 is a diagram depicting an example method 220 for detecting, measuring, analyzing and/or navigating the terrain of the crop field using the sensing system 100 in accordance one embodiment of the present invention. As indicated by blocks 222, a plurality of sensors or devices 110, or cluster of sensors and devices 110, can sense or detect certain predefined crop-related data values, including crop-related data values sensed or detected from a certain portion or portions 32, 34 of the harvesting mechanism 10 and at certain varying distances or spatial planes relative to the harvesting mechanism 10, including a first plane 40 and a second plane 42. Block 224 illustrates how the processor 120 can receive sensed crop-related data values from the plurality of sensors or devices 110, or cluster of sensors and devices 110. For example, the processor 120 can receive first crop-related data values 160 and second crop-related data values 162 from one sensor or device 110, or cluster of sensors and devices 110, or from a plurality of sensors or devices 110, or clusters of sensors and devices 110. As indicated by block 226, according to one embodiment of the present invention, the processor 120 can derive additional secondary crop-related data values 164 and/or tertiary crop-related data values 166 from the first crop-related data values 160 and second crop-related data values 162 based on predefined characteristics, parameters, or thresholds. As indicated by block 228, the processor 120 can then identify certain predefined conditions or characteristics from the crop-related data values provided to and derived by the processor 120 based on predefined characteristics, parameters, or thresholds. Then, as indicated by block 230 and in accordance with one embodiment of the present invention, the processor 120 can correlate the applicable crop-related data values upon instructions provided by the memory 130 or a module 132 contained therein. Such correlation can include weighting the received and/or derived crop-related data values based on predefined parameters, correlating the relevant crop-related data values to the time-related data values provided by a timekeeping module 134 of the memory 130, and/or combining or integrating first crop-related data values 160, second crop-related data values 162, second crop-related data values 164, tertiary crop-related data values 166, and/or any other applicable crop-related data values. As indicated by block 232, the processor 120 can analyze the received and/or derived data based upon instructions provided by the memory 130, including instructions to conduct known data or statistical analysis. Block 234 indicates how the processor 120 can generate deliverable data or signals following instructions provided by the memory 130 or a module 132 contained therein. Such deliverable data or signals can be determined on a set width-by-set width basis, row-by-row basis, or a plant-by-plant basis. Further, such deliverable data can be utilized to manipulate or automatically adjust the operational characteristics of the harvester 2 and/or the harvesting mechanism 10, either manually or automatically, to avoid, prevent, or otherwise mitigate the unnecessary wear and tear of the harvesting mechanism 10 and its components or damage to the harvesting mechanism 10, the harvester 2, or any other related agricultural machine or implement associated with crop harvesting. In one embodiment, the processor 120 can remotely transmit the deliverable data to the harvester 2 or the harvesting mechanism 10. In another embodiment, the deliverable data can be output via a wireless communication device, a removable memory port (e.g., a USB port), or other device for transmitting data to and from the processor 120 or the output module 140.

The deliverable data produced from the two methods 200, 220 described above can be used by an individual, an operator, or a device to make adjustments to the operational characteristics to the harvester 2, the harvesting mechanism 10, or any other element thereof. In one embodiment, the deliverable data produced from the two methods 200, 220 described above can be used to adjust the operational characteristics of the entire and/or a portion of the harvesting mechanism 10, for example adjusting the operational characteristics of at least one row unit 14. In another embodiment, the deliverable data produced from the two methods 200, 220 described above can be used to adjust the operational characteristics of multiple portions of the harvesting mechanism in the same or different manner and either simultaneously or sequentially. For example, the two methods 200, 220 can be used to selectively adjust the operational pace of a row unit 14 in response to sensed, derived, and/or correlated crop-related data values indicating an anomaly, such as the absence of crop plants, row unit plugging, ingestion of undesirable foreign objects by the harvesting mechanism 10, and other similar events, while also adjusting the operational characteristics of another row unit 14.

In another embodiment of the present invention, deliverable data produced from the two methods 200, 220 described above can be used by an individual, an operator or a device to make adjustments to the operational characteristics to the harvester 2 to navigate the terrain of the crop field or to avoid sensed or detected obstructions in the crop field. For example, the driving direction of the harvester 2 can be halted or adjusted to avoid a sensed or detected obstruction or obstacle in the crop field, such as obscured trees, bushes, non-crop plants, well heads, drainage stand pipes, fence, fence posts, powerline posts, above-ground utilizes, farm machinery and implements, wildlife, other hazards, and the like, before the harvester 2 makes contact with the obstruction or obstacle.

From the accompanying materials, it will be seen that the invention is one well adapted to attain all the ends and objects set forth herein with other advantages which are obvious and which are inherent to the structure. It will be understood that certain features and subcombinations are of utility and may be employed without reference to other features and subcombinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described in the accompanying materials and illustrated in the drawings are presented by way of example only and are not intended to limit the concepts and principles of the present invention. Thus, there has been shown and described several embodiments of a novel invention. As is evident from the description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A sensing system for use with a harvester while the harvester traverses a crop field, comprising:
a first sensor to sense a predefined measurable element associated with a first portion of a plurality of portions, independent of other portions of the plurality of portions, of a utilized width currently engaged in harvesting and output a first crop-related data value;
a second sensor to sense a predefined measurable element associated with the first portion of the plurality of portions of the utilized width currently engaged in harvesting and output a second crop-related data value; and
at least one processing unit in communication with an output module, the at least one processing unit to:
receive the first crop-related data value and the second crop-related data value associated with the first portion of a plurality of portions of the utilized width currently engaged in harvesting; and
cause the output of a signal based on the first crop-related data value and the second crop-related data value via the output module.

2. The sensing system of claim 1, wherein the first portion comprises a single crop row of the utilized width.

3. The sensing system of claim 1, wherein the first portion comprises a single crop plant of the utilized width.

4. The sensing system of claim 1, wherein the signal is a warning to an operator of the harvester.

5. The sensing system of claim 1, wherein the output module is configured to adjust an operational characteristic of the harvester upon instruction from the at least one processing unit.

6. The sensing system of claim 1, wherein the output module is configured to adjust an operational characteristic of a harvesting mechanism upon instruction from the at least one processing unit.

7. The sensing system of claim 1 further comprising a timekeeping device configured to generate a time-related data value relative to the operation of the harvester, wherein the at least one processing unit causes the output of a signal based on the first crop-related data value, the second crop-related data, and the time-related data value via the output module.

8. The sensing system of claim 1 further comprising an input module to output an input value, wherein the at least one processing unit causes the output of a signal based on the first crop-related data value, the second crop-related data, and the input value via the output module.

9. A harvesting mechanism for use with a harvester while the harvester traverses a crop field, comprising:
a harvesting mechanism; and
a sensing system supported by the harvesting mechanism, the sensing system comprising:
a first sensor to sense a predefined measurable element associated with a first portion of a plurality of portions, independent of other portions of the plurality of portions, of a utilized width currently engaged in harvesting and output a first crop-related data value;
a second sensor to sense a predefined measurable element associated with the first portion of the plurality of portions of the utilized width currently engaged in harvesting and output a second crop-related data value; and
at least one processing unit in communication with an output module, the at least one processing unit to:
receive the first crop-related data value and the second crop-related data value associated with the first portion of a plurality of portions of the utilized width currently engaged in harvesting; and
cause the output of a signal based on the first crop-related data value and the second crop-related data value via the output module.

10. The harvesting mechanism of claim 9, wherein the first portion comprises a single crop row of the utilized width.

11. The harvesting mechanism of claim 9, wherein the signal is a warning to an operator of the harvester.

12. The harvesting mechanism of claim 9, wherein the output module is configured to adjust an operational characteristic of the harvesting mechanism upon instruction from the at least one processing unit.

13. The harvesting mechanism of claim 9 further comprising an input to output an input value, wherein the at least one processing unit causes the output of a signal based on the first crop-related data value, the second crop-related data, and the input value via the output module.

14. The harvesting mechanism of claim 9, wherein:
the first sensor is configured to sense the predefined measurable element at a first distance relative to the harvesting mechanism; and
the second sensor is configured to sense the predefined measurable element at a second distance relative to the harvesting mechanism.

15. The harvesting mechanism of claim 14, wherein:
the first distance is between about five feet behind and ten feet in front of the harvesting mechanism; and
the second distance is between about five feet behind and ten feet in front of the harvesting mechanism.

16. A harvester comprising:
an agricultural machine;
a harvesting mechanism operably attached to the agricultural machine; and
a sensing system for use with the agricultural machine while the agricultural machine traverses a crop field supported by the harvesting mechanism, the sensing system comprising:
a first sensor to sense a predefined measurable element associated with a first portion of a plurality of portions, independent of other portions of the plurality of portions, of a utilized width currently engaged in harvesting and output a first crop-related data value;
a second sensor to sense a predefined measurable element associated with the first portion of the plurality of portions of the utilized width currently engaged in harvesting and output a second crop-related data value; and
at least one processing unit in communication with an output module, the at least one processing unit to:
receive the first crop-related data value and the second crop-related data value associated with the first portion of a plurality of portions of the utilized width currently engaged in harvesting; and
cause the output of a signal based on the first crop-related data value and the second crop-related data value via the output module.

17. The harvester of claim 16, wherein the agricultural machine is a harvesting machine.

18. The harvester of claim 16, wherein the first portion comprises a single crop row of the utilized width.

19. The harvester of claim 16, wherein the signal is a warning to an operator of the harvester.

20. The harvester of claim 16, wherein the output module is configured to adjust an operational characteristic of the harvester upon instruction from the at least one processing unit.

21. The harvester of claim 16 further comprising an input to output an input value, wherein the at least one processing unit causes the output of a signal based on the first crop-related data value, the second crop-related data, and the input value via the output module.

22. The harvester of claim 16, wherein:
the first sensor is configured to sense the predefined measurable element at a first distance between about five feet behind and ten feet in front of the harvesting mechanism; and
the second sensor is configured to sense the predefined measurable element at a second distance between about five feet behind and ten feet in front of the harvesting mechanism.

23. A method for measuring a crop-related data value as a harvester traverses a crop field, comprising:
sensing a predefined measurable element associated with a first sensor at a first distance between about five feet behind and ten feet in front of a harvesting mechanism, the first sensor generating a first crop-related data value related to the predefined measurable element;
storing the first crop-related data value in a memory;
recording a first time-related data value of a timekeeping module, the timekeeping module in communication with the memory; and
storing in memory a first association between the first crop-related data value and the first time-related data value.

24. The method of claim 23, further comprising adjusting an operational characteristic of the harvesting mechanism based on the first crop-related data value via an output module upon instruction from an at least one processing unit.

25. The method of claim 23, further comprising:
sensing a predefined measurable element associated with a second sensor at a second distance between about five feet behind and ten feet in front of a harvesting mechanism, the second sensor generating a second crop-related data value related to the predefined measurable element;
storing the second crop-related data value in the memory;
recording a second time-related data value of the timekeeping module; and
storing in memory a second association between the first crop-related data value and the first time-related data value; and
storing in memory a third association between the first association and the second association.

26. The method of claim 25, further comprising adjusting an operational characteristic of the harvesting mechanism based on the first crop-related data value and the second crop-related data value via an output module upon instruction from an at least one processing unit.
